(19) United States
(12) Patent Application Publication
(10) Pub. No.: US 2025/0363594 A1
(43) Pub. Date: Nov. 27, 2025

(54) GENERATING COMPOSITE IMAGES

(71) Applicant: QUALCOMM Incorporated, San Diego, CA (US)

(72) Inventors: Siddartha PENDYALA, Hyderabad (IN); Rajat SHARMA, Hamirpur (IN); Sandeep RAMISETTY, Hyderabad (IN); Prajit Sivasankaran NAIR, Hyderabad (IN); Pradeep VEERAMALLA, Hyderabad (IN)

(21) Appl. No.: 18/671,830

(22) Filed: May 22, 2024

(51) Int. Cl. G06T 5/50; G06T 7/246; H04N 23/80

(52) U.S. Cl. CPC G06T 5/50; G06T 7/248; H04N 23/80; G06T 2207/10144; G06T 2207/20208; G06T 2207/20212

(57) ABSTRACT

Systems and techniques are described herein for generating composite image data. For instance, a method for generating composite image data is provided. The method may include generating a first composite image based on a first image, a second image, and a first motion threshold; generating a second composite image based on the first image, the second image, and a second motion threshold; comparing a region of the first composite image with a region of the second composite image; and outputting image data based on the comparison.

### TECHNICAL FIELD

The present disclosure generally relates to generating composite images. For example, aspects of the present disclosure include systems and techniques for generating composite images using multiple motion thresholds.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others. In some cases, a camera can capture multiple images of a scene using different image-capture settings and can combine the captured images into a single image frame.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for generating composite image data. According to at least one example, a method is provided for generating composite image data. The method includes: generating a first composite image based on a first image, a second image, and a first motion threshold; generating a second composite image based on the first image, the second image, and a second motion threshold; comparing a region of the first composite image with a region of the second composite image; and outputting image data based on the comparison.

In another example, an apparatus for generating composite image data is provided that includes at least one memory and at least one processor (e.g., configured in circuitry) coupled to the at least one memory. The at least one processor configured to: generate a first composite image based on a first image, a second image, and a first motion threshold; generate a second composite image based on the first image, the second image, and a second motion threshold; compare a region of the first composite image with a region of the second composite image; and output image data based on the comparison.

In another example, a non-transitory computer-readable medium is provided that has stored thereon instructions that, when executed by one or more processors, cause the one or more processors to: generate a first composite image based on a first image, a second image, and a first motion threshold; generate a second composite image based on the first image, the second image, and a second motion threshold; compare a region of the first composite image with a region of the second composite image; and output image data based on the comparison.

In another example, an apparatus for generating composite image data is provided. The apparatus includes: means for generating a first composite image based on a first image, a second image, and a first motion threshold; means for generating a second composite image based on the first image, the second image, and a second motion threshold; means for comparing a region of the first composite image with a region of the second composite image; and means for outputting image data based on the comparison.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image-processing system, according to various aspects of the present disclosure;

FIG. 2 includes two example images with different exposures used to create a composite image;

FIG. 3 is a block diagram illustrating an example system that may generate a composite image based on a shorter-exposure image and a longer-exposure image, according to various aspects of the present disclosure;

FIG. 4A is a block diagram with example images illustrating an example system for generating a composite image based on a shorter-exposure image, a longer-exposure image, and a motion threshold, according to various aspects of the present disclosure;

FIG. 4B is a block diagram with example images illustrating an example system for generating a composite image based on a shorter-exposure image, a longer-exposure image, and a motion threshold, according to various aspects of the present disclosure;

FIG. 5 is a block diagram with example images illustrating an example system for generating a composite image based on a shorter-exposure image and a longer-exposure image, according to various aspects of the present disclosure;

FIG. 6 is a block diagram illustrating an example system for generating a composite image based on a shorter-exposure image and a longer-exposure image;

FIG. 7 is a flow diagram illustrating an example process for generating a composite image, in accordance with aspects of the present disclosure;

FIG. 8 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.), vehicles, computing systems or devices of vehicles, etc. are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

In photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

Many cameras are equipped with an automatic exposure or “auto exposure” mode, where the image-capture settings (e.g., exposure time, lens aperture, etc.) of the camera may be automatically adjusted to match, as closely as possible, the luminance of a scene or subject being photographed. In some cases, an automatic exposure control (AEC) engine can perform AEC to determine image-capture settings for an image sensor. An AEC engine may seek to limit a number of pixels in an image frame that are overexposed and a number of pixels in an image frame that are underexposed. For example, an AEC engine may examine a first image, and determine image-capture settings for a subsequent image based on the exposure of the first image. For example, when a camera is capturing video data, the AEC engine may examine each frame and determine image-capture settings for each frame based on the exposure of the preceding frames. As another example, a camera may capture test frames (which may be displayed, for example, as preview frames to a user as they are composing a shot), and the AEC engine may determine image-capture settings based on the exposure of test frames.

In addition to AEC, many cameras are equipped with an auto-focus mode and/or an auto-white balance (AWB) mode. The auto-focus mode may control a position of a lens of the camera to set a focal point when capturing an image. The AWB mode may adjust values of stored pixels such that pixels representing white objects in the scene are white in captured image.

In photography and videography, a technique called high dynamic range (HDR) allows the dynamic range of image frames captured by a camera to be increased beyond the native capability of the camera. In this context, the term “dynamic range” refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames into a single image frame. The combination of image frames with different exposures can result in an image with a dynamic range higher than that of each individual image frame captured and combined to form the HDR image frame. For example, the electronic device can create a high dynamic image frame by combining two or more image frames with different exposures into a single frame. An AEC engine may determine various exposure settings depending on the scene and provide that information to an image sensor. The image sensor may capture image frames based on the various exposure settings. For example, the AEC engine may determine shorter-exposure durations and longer-exposure durations for HDR. HDR is a feature often used by electronic devices, such as smartphones and mobile devices, for various purposes. For example, in some cases, a smartphone can use HDR to achieve a better image quality (e.g., at least in terms of dynamic range) than image quality achieved by a digital single-lens reflex (DSLR) camera.

In the present disclosure, the term “combine,” and like terms, with reference to images or image data, may refer to any suitable techniques for using information (e.g., pixels) from two or more images to generate an image (e.g., a “composite” image). For example, pixels from a first image and pixels from a second image may be combined to generate a composite image. In such cases some of the pixels of the composite image may be from the first image and others of the pixels of the composite image may be from the second image. In some cases, some of the pixels from the first image and the second image may be merged, fused, or blended. For example, color and/or intensity values for pixels of the composite image may be based on respective pixels from both the first image and the second image. For instance, a given pixel of the composite image may be based on an average, or a weighted average, between a corresponding pixel of the first image and a corresponding pixel of the second image (e.g., the corresponding pixels of the first image and the second image may be blended). As one example, a central region of a first image may be included in a composite image. Further, an outer region of a second image may be included in the composite image. Pixels surrounding the central region in the composite image may be based on weighted averages between corresponding pixels of the first image and corresponding pixels of the second image. In other words, pixels of the first image surrounding the central region may be merged, fused, or blended with pixels of the second image inside the outer region.

In some cases, an imaging device can generate an HDR image by combining multiple images captured with different image-capture settings. For instance, an imaging device can generate an HDR image by combining a shorter-exposure image captured with a shorter exposure time and a longer-exposure image captured with a longer exposure time that is longer than the shorter exposure time. As another example, the imaging device can create an HDR image using a shorter-exposure image, a medium exposure image (that is capture with a medium exposure time that is between the shorter exposure time and the longer exposure time), and a longer-exposure image.

Because shorter-exposure images are generally darker, they preserve the most detail in the highlights (brighter areas) of a photographed scene. Medium-exposure images and the longer-exposure images are generally brighter than shorter-exposure images, and may be overexposed (e.g., too bright to make out details) in the highlight portions (brighter areas) of the scene. Because longer-exposure images generally include brighter portions, they may preserve detail in the shadows (darker areas) of a photographed scene. Medium-exposure images and the shorter-exposure images are generally darker than longer-exposure images, and may be underexposed (e.g., too dark to make out details in) in the shadow portions (darker areas) of the scene, making their depictions of the shadows too dark to observe details. To generate an HDR image, the imaging device may, for example, use portions of the shorter-exposure image to depict highlights (brighter areas) of the photographed scene, use portions of the longer-exposure image depicting shadows (darker areas) of the scene, and use portions of the medium-exposure image depicting other areas (other than highlights and shadows) of a scene.

To combine pixels from a shorter-exposure image and a longer-exposure image, an HDR technique may be based on motion For example, while a longer-exposure image is captured, objects in the scene may move, which may result in blur in the longer-exposure image. A corresponding shorter-exposure image may exhibit less blur than the longer-exposure image because the object in the scene may have moved less during the shorter exposure than the object moved during the longer exposure. For pixels that exhibit motion, the HDR technique may prefer pixels from a shorter-exposure image over pixels from a longer-exposure image so that the HDR technique does not include blurry pixels in the composite image.

Some HDR techniques may determine motion values for pixels of images and combine pixels from the images based on the motion values. For example, the HDR techniques may compare a shorter-exposure image to a longer-exposure image and determine a motion value for each pixel of both the shorter-exposure image and the longer-exposure image based on the comparison. For pixels with higher motion values, the HDR techniques may include pixels from the shorter-exposure image. In case of pixels with lower motion values and/or no motion, the HDR techniques may include pixels from the corresponding exposure image based on the bright or dark area or the luminosity of the pixel. Whether a pixels has a higher motion value or a lower motion value may be based on a motion threshold. For example, motion values above the motion threshold may be defined as higher motion values and motion values below the motion threshold may be defined as lower motion values.

There are two undesirable artifacts that can be present in HDR images-noise and ghosting. Ghosting may be the result of including pixels from a longer-exposure image that represent an object in a first position in a composite image and pixels from a shorter-exposure image that also represent the object in a second position in the composite image. A composite image that exhibits ghosting may include two representations of the same object at different positions within the composite image.

Ghosting may be alleviated by setting a motion threshold low. Setting a motion threshold lower may increase the chances of the HDR technique correctly identifying true motion in images. For example, if a motion threshold is lower, then lower motion values will cross the motion threshold than if the motion threshold were higher. For example, an image may include motion values ranging from 0 to 1. If the motion threshold is 0.25, then more of the motion values would be determined to be higher motion values and more corresponding pixels from the shorter-exposure image would be selected for inclusion in the composite image rather than the corresponding pixels from the longer-exposure image. Setting the motion threshold lower may cause fewer pixels of the longer-exposure image to be included in the composite image which may reduce the chances of ghosting. In contrast, setting the motion value higher may result in fewer pixels of the shorter-exposure image being included in the composite image which may increase the chances of ghosting.

A lower motion threshold may result in noise. Setting a motion value lower may increase the chances of false positives in detecting motion in images. For example, some pixels may be noisy in a shorter-exposure image and may thus have motion values above a lower motion threshold. For example, pixels of a darker portion of a shorter-exposure image may have motion values of 0.5. The darker portion of the shorter-exposure image may exhibit noise, based on the darker portion being underexposed. If the motion threshold is 0.25, pixels representing the darker portion may be selected for inclusion in the composite image, resulting in noise in the composite image.

A higher motion threshold may alleviate such noise. For example, if the motion threshold were 0.75, pixels from the darker portion of the shorter-exposure image would not be selected and pixels of the longer-exposure image would be selected instead. Additionally or alternatively, pixels from the shorter-exposure image may be blended with corresponding pixels from the longer-exposure image.

Some HDR techniques seek to set a motion threshold to achieve a balance between ghosting and noise. For example, some HDR techniques seek to set a motion threshold high enough to exclude pixels exhibiting noise, and not true object motion, from crossing the threshold. Such HDR techniques also seek to set the motion threshold low enough to not miss capturing true motion from objects.

Systems, apparatuses, methods (also referred to as processes), and computer-readable media (collectively referred to herein as “systems and techniques”) are described herein for generating composite images. For example, the systems and techniques described herein may generate a first composite image based on a shorter-exposure image, a longer-exposure image, and a lower motion threshold. The systems and techniques may also generate a second composite image based on the shorter-exposure image, the longer-exposure image and a higher motion threshold. The systems and techniques may compare regions of the first composite image with regions of the second composite image and determine similarity scores for each of the regions. The systems and techniques may then select regions from the first composite image and regions from the second composite image for inclusion in a third composite image based on the similarity scores.

The first composite image (generated using a lower motion threshold) may exhibit less ghosting than the second composite image (generated using a higher motion threshold). The second composite image may exhibit less noise than the first composite image.

The systems and techniques may compare the regions of the first composite image with the regions of the second composite image using a structural-similarity algorithm. The structure-similarity algorithm may score differences between regions that are based on noise lower than differences between regions that are based on ghosting. For example, images including differences based on ghosting may be more similar to one another, and thus receive a higher similarity score, than images including differences based on noise. The systems and techniques may use similarity scores as an indication of whether a region exhibits noise or ghosting.

The systems and techniques may select, for inclusion in the third composite image, regions of the first composite image (which may exhibit less ghosting and more noise) based on the regions of the first composite image having relatively high similarity scores. Also, the systems and techniques may select, for inclusion in the third composite image, regions of the second composite image (which may exhibit less noise and more ghosting) based on the regions of the second composite image having relatively low similarity scores (indicating differences based on noise).

The systems and techniques may be implemented in cameras and/or devices including cameras. For example, the systems and techniques may be implemented in cameras, smart phones, vehicles, and/or devices implementing extended reality (XR) (which may include virtual reality (VR), augmented reality (AR), and/or mixed reality (MR)). The systems and techniques may improve the capture of single images (e.g., snap shots), the capture of video data (e.g., generating composite images for each frame of video data), and/or the display of preview images (e.g., generating composite images for displaying at a display of a device while a user is pointing their camera, for example, before the user presses a shutter button initiating an image capture).

The systems and techniques may improve the generation of composite images. For example, the systems and techniques may generate composite images that exhibit less ghosting and/or noise than composite images generated according to other HDR techniques. Additionally or alternatively, the systems and techniques may enable the generation of composite images having a higher dynamic range than composite images generated according to other HDR techniques. For example, by reducing noise and/or ghosting, the systems and techniques may enable a composite-image generation system to capture images using a wider range of exposure times and/or to perform other or additional processing to improve the input or output images with less concern about ghosting and/or noise.

Various aspects of the application will be described with respect to the figures below.

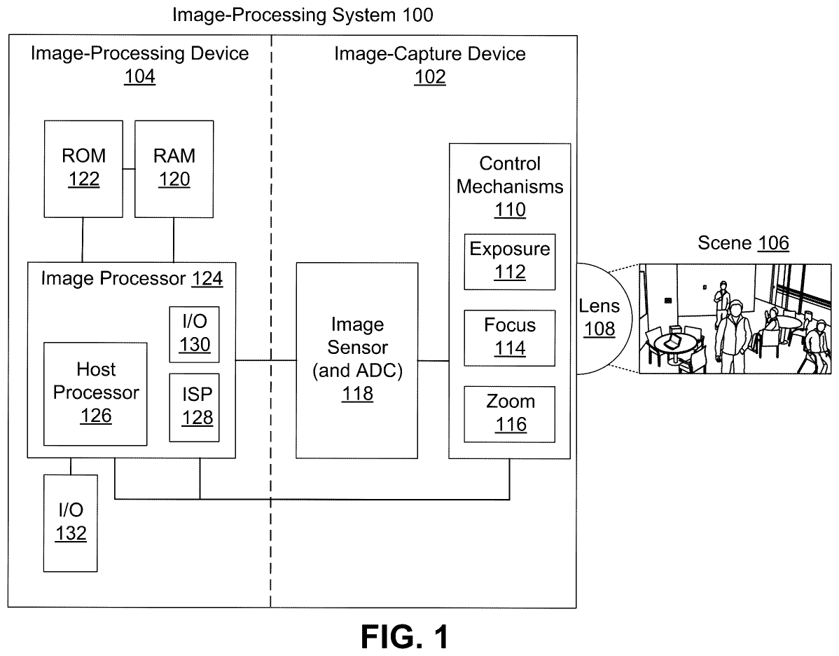

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an infrared (IR) cut filter, an ultraviolet (UV) cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complementary metal-oxide semiconductor (CMOS), an N-type metal-oxide semiconductor (NMOS), a hybrid CCD/CMOS sensor (e.g., sCMOS), or some other combination thereof.

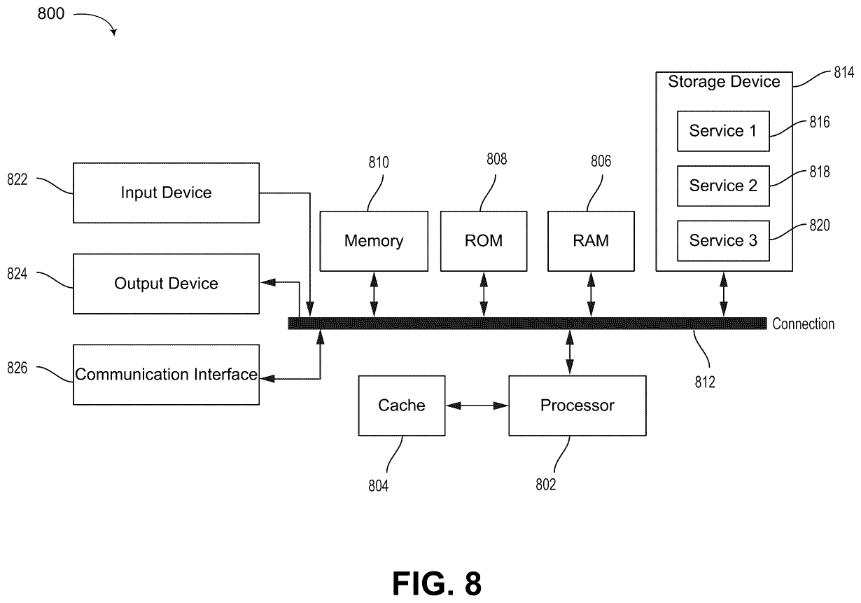

The image processor 124 may include one or more processors, such as one or more image signal processors (ISPs) (including ISP 128), one or more host processors (including host processor 126), and/or one or more of any other type of processor discussed with respect to the computing-device architecture 800 of FIG. 8. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., third generation (3G), fourth generation (4G) or long-term evolution (LTE), fifth generation (5G), etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an Internet Protocol (IP) camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an head-mounted device (HMD), smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 800 shown in FIG. 8 and further described below can include the image-processing system 100, the image-capture device 102, the image-processing device 104, or a combination thereof.

In some examples, the image-processing system 100 can create an HDR image using multiple image frames with different exposures. For example, the image-processing system 100 can create an HDR image using a shorter-exposure (SE) image, a medium exposure (ME) image, and a longer-exposure (LE) image. As another example, the image-processing system 100 can create an HDR image using an SE image and an LE image. In some cases, the image-processing system 100 can write the different image frames from one or more camera frontend engines to a memory device, such as a DDR memory device or any other memory device (e.g., RAM 120). A post-processing engine can then retrieve the image frames and fuse (e.g., merge, combine) them into a single image.

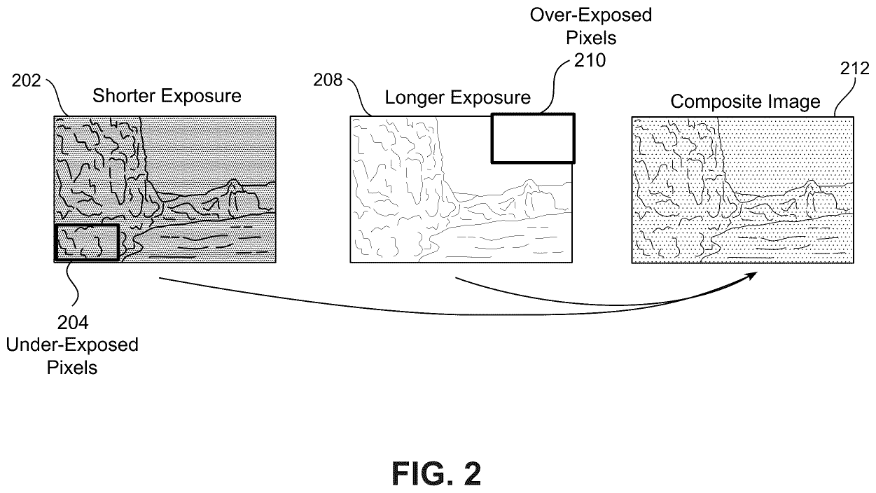

FIG. 2 includes two example images with different exposures used to create a composite image (e.g., composite image 212). For example, FIG. 2 shows a shorter-exposure image 202, a longer-exposure image 208, and composite image 212 generated by combining pixels from shorter-exposure image 202 and longer-exposure image 208. Shorter-exposure image 202 includes under-exposed pixels 204, and longer-exposure image 208 includes over-exposed pixels 210. As shown in FIG. 2, under-exposed pixels 204 of shorter-exposure image 202 and over-exposed pixels 210 of the longer-exposure image 208 do not contribute to the pixels of the composite image 212. Other pixels of shorter-exposure image 202 may be blended with corresponding pixels of longer-exposure image 208 to generate corresponding pixels of composite image 212.

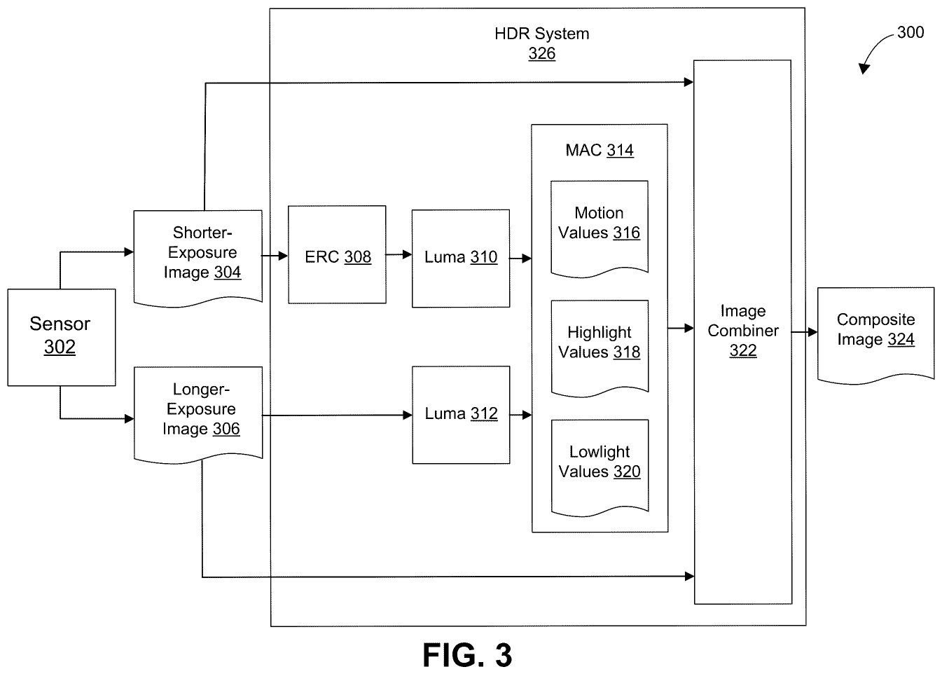

FIG. 3 is a block diagram illustrating an example system 300 that may generate a composite image 324 based on a shorter-exposure image 304 and a longer-exposure image 306, according to various aspects of the present disclosure. For example, system 300 may include an implementation of a high-dynamic-resolution (HDR) system 326. HDR system 326 may generate composite image 324 based on shorter-exposure image 304 and longer-exposure image 306.

Sensor 302 may be an image sensor capable of capturing light and generating image data. Image-capture device 102 of FIG. 1 may be an example of sensor 302. Sensor 302 may generate shorter-exposure image 304 and longer-exposure image 306. Shorter-exposure image 304 may be captured over a shorter exposure time than longer-exposure image 306.

HDR system 326 may be a representation of an algorithm. HDR system 326 may be implemented in an image signal processor (ISP). HDR system 326 may include several blocks that may perform various operations. The blocks illustrated in HDR system 326 are provided as an example. One or more of the blocks may be combined or omitted in other aspects. HDR system 326 may include additional steps, operations, or blocks in other aspects.

HDR system 326 may include an exposure ratio compensation (ERC) block (ERC 308). At ERC 308, shorter-exposure image 304 may be exposure compensated.

At luma 310, luma values of shorter-exposure image 304 may be separated from intensity values. Similarly, at luma 312 luma values of longer-exposure image 306 may be separated from intensity values. Luma 310 may provide luma and/or intensity values of shorter-exposure image 304 to motion adaptive combiner (MAC) 314. Similarly, luma 312 may provide luma and/or intensity values of longer-exposure image 306 to motion values 316.

MAC 314 may determine weights for combining pixels of shorter-exposure image 304 with pixels of longer-exposure image 306. For example, MAC 314 may determine motion values 316, highlight values 318, and lowlight values 320.

Motion values 316 may be, or may include, a set of values, for example, including one value per pixel of shorter-exposure image 304. Longer-exposure image 306 and shorter-exposure image 304 may include the same number of pixels. So, it may also be said that motion values 316 may include one value for each pixel of longer-exposure image 306. Each of the values of motion values 316 may be based on motion related to shorter-exposure image 304 and/or longer-exposure image 306. For example, motion values 316 may indicate, on a pixel-by-pixel basis, an amount of motion determined based on pixels of shorter-exposure image 304 and/or corresponding pixels of longer-exposure image 306. MAC 314 may determine the amounts of motion of the pixels of shorter-exposure image 304 and/or longer-exposure image 306 based on differences between shorter-exposure image 304 and longer-exposure image 306. As an example, MAC 314 may perform an optical-flow analysis of shorter-exposure image 304 and longer-exposure image 306 to determine the amounts of motion.

Highlight values 318 may be based on intensity values of longer-exposure image 306. Highlight values 318 may indicate how overexposed each pixel of longer-exposure image 306 is. Highlight values 318 may be used (e.g., by image combiner 322) to determine whether to include pixels of shorter-exposure image 304 or corresponding pixels of longer-exposure image 306 in composite image 324. Additionally, highlight values 318 be used (e.g., by image combiner 322) to blend pixels of shorter-exposure image 304 with pixels of longer-exposure image 306.

Lowlight values 320 may be based on intensity values of longer-exposure image 306. Lowlight values 320 may indicate how underexposed each pixel of shorter-exposure image 304 is. Lowlight values 320 may be used (e.g., by image combiner 322) to determine whether to include pixels of shorter-exposure image 304 or corresponding pixels of longer-exposure image 306 in composite image 324. Additionally, lowlight values 320 may be used (e.g., by image combiner 322) to blend pixels of shorter-exposure image 304 with pixels of longer-exposure image 306.

MAC 314 may determine (based on motion values 316, highlight values 318, and/or lowlight values 320) a single weight that may be used (e.g., by image combiner 322) to select and/or blend pixels of shorter-exposure image 304 and pixels of longer-exposure image 306. For example, MAC 314 may determine, for each pixel of shorter-exposure image 304, a value from 0 to 1, where a 0 indicates that the pixel of shorter-exposure image 304 should be included in composite image 324, where a 1 indicates that the pixels of longer-exposure image 306 should be included in composite image 324, and a value between 0 and 1 indicates a blending weight for blending the pixel of shorter-exposure image 304 with the pixel of longer-exposure image 306.

Image combiner 322 may generate composite image 324 based on shorter-exposure image 304, longer-exposure image 306, and the weights provided by MAC 314. For example, as indicated by the weights provided by MAC 314, image combiner 322 may select or blend pixels of shorter-exposure image 304 with pixels of longer-exposure image 306 to generate composite image 324.

In some aspects, MAC 314 and/or image combiner 322 may operate using thresholds and/or hierarchies. For example, for any pixel of longer-exposure image 306 that is more intense than a brightness threshold, MAC 314 and/or image combiner 322 may determine to include in composite image 324 a pixel of shorter-exposure image 304 instead. Additionally or alternatively, for any pixel of shorter-exposure image 304 that is less intense than a darkness threshold, MAC 314 and/or image combiner 322 may determine to include in composite image 324 a pixel of longer-exposure image 306 instead. For pixels of shorter-exposure image 304 that are not less intense than the darkness threshold and corresponding pixels of longer-exposure image 306 that are not more intense than the brightness threshold, MAC 314 and/or image combiner 322 may determine to blend the pixels from shorter-exposure image 304 and longer-exposure image 306.

Additionally or alternatively, MAC 314 and/or image combiner 322 may determine to include (in composite image 324) pixels of shorter-exposure image 304 or longer-exposure image 306 based on whether motion values 316 of the pixels exceed a motion threshold. In some aspects, the determination based on motion values 316 may override determinations based on intensities, including determinations to blend. For example, for a given pixel of composite image 324, if the corresponding pixel of longer-exposure image 306 exceeds the motion threshold, MAC 314 and/or image combiner 322 may determine to use the pixel of shorter-exposure image 304, for example, without blending.

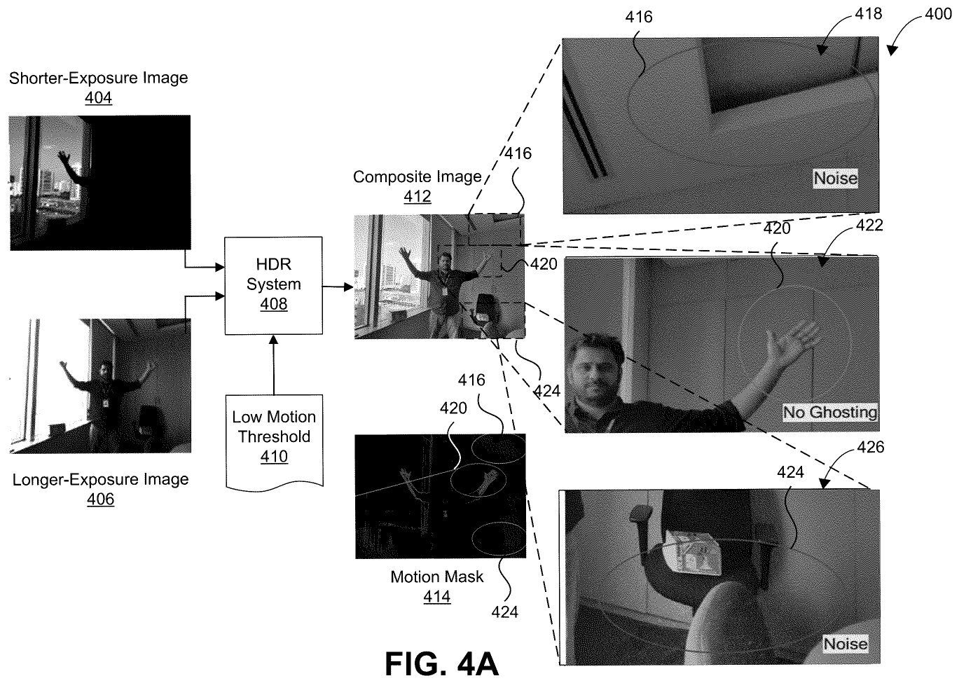

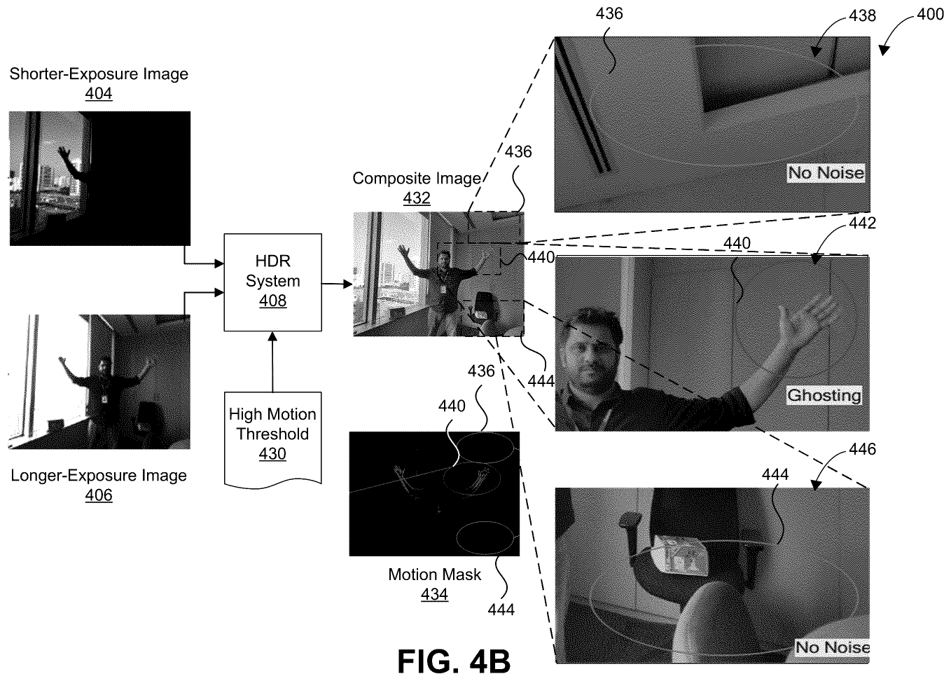

FIG. 4A is a block diagram with example images illustrating an example system 400 for generating a composite image 412 based on shorter-exposure image 404, longer-exposure image 406, and motion threshold 410, according to various aspects of the present disclosure. FIG. 4B is a block diagram with example images illustrating an example system 400 for generating a composite image 432 based on shorter-exposure image 404, longer-exposure image 406, and motion threshold 430, according to various aspects of the present disclosure.

HDR system 326 of FIG. 3 may be an example of HDR system 408 of FIG. 4A and FIG. 4B. For example, HDR system 408 may combine pixels of shorter-exposure image 404 with pixels of longer-exposure image 406 based on intensities of shorter-exposure image 404 and longer-exposure image 406 and based on motion values.

In FIG. 4A, system 400 is illustrated and described as using motion threshold 410 that may be a relatively low motion threshold and in FIG. 4B, system 400 is illustrated and described using motion threshold 430 that may be relatively high. For example, motion threshold 410 may be lower than motion threshold 430. Composite image 412 (generated based on motion threshold 410, which may be relatively low) may exhibit more noise than composite image 432 of FIG. 4B but less ghosting than composite image 432. Composite image 432 (generated based on motion threshold 430, which may be relatively high) may exhibit more ghosting than composite image 412 but less noise than composite image 412.

FIG. 4A includes a representation of a motion mask 414. Pixels of motion mask 414 may be indicative whether motion related to pixels of shorter-exposure image 404, longer-exposure image 406, and/or composite image 412 exceeds motion threshold 410. For example, brighter pixels in motion mask 414 indicate motion values corresponding to shorter-exposure image 404, longer-exposure image 406, and/or composite image 412 that exceed motion threshold 410. Darker pixels in motion mask 414 indicate motion values corresponding to shorter-exposure image 404, longer-exposure image 406, and/or composite image 412 that do not exceed motion threshold 410.

FIG. 4B includes a representation of a motion mask 434. Pixels of motion mask 434 may be indicative whether motion related to pixels of shorter-exposure image 404, longer-exposure image 406, and/or composite image 432 exceeds motion threshold 430. For example, brighter pixels in motion mask 434 indicate motion values corresponding to shorter-exposure image 404, longer-exposure image 406, and/or composite image 432 that exceed motion threshold 430. Darker pixels in motion mask 434 indicate motion values corresponding to shorter-exposure image 404, longer-exposure image 406, and/or composite image 412 that do not exceed motion threshold 430.

Comparing motion mask 414 and motion mask 434, it can be seen that more motion values related to shorter-exposure image 404, longer-exposure image 406, and/or composite image 412 exceed motion threshold 410 than motion values related to shorter-exposure image 404, longer-exposure image 406, and/or composite image 432 exceed motion threshold 430. More motion values related to shorter-exposure image 404, longer-exposure image 406, and/or composite image 412 exceed motion threshold 410 than motion values related to shorter-exposure image 404, longer-exposure image 406, and/or composite image 432 exceed motion threshold 430 because motion threshold 410 is lower than motion threshold 430. For example, in motion mask 414 and motion mask 434, it can be seen that the person represented by shorter-exposure image 404 and longer-exposure image 406 is moving their hands. More pixels of shorter-exposure image 404 and longer-exposure image 406 exceed motion threshold 410 than motion threshold 430 because motion threshold 410 is lower than motion threshold 430.

By comparing FIG. 4A and FIG. 4B, it can be seen that an area 416 of composite image 412 (illustrated in composite image 412, in motion mask 414, and in inset 418) exhibits more noise than area 436 of FIG. 4B. Similarly, an area 424 (illustrated in composite image 412, motion mask 414, and inset 426) exhibits more noise than area 444 of FIG. 4B. However, an area 420 (illustrated in composite image 412, motion mask 414, and inset 422) may exhibit less ghosting than area 440 of FIG. 4B. Composite image 412 may exhibit more noise and less ghosting than composite image 432 based on motion threshold 410 being lower than motion threshold 430.

For each pixel for which a motion value exceeds the relevant motion threshold, HDR system 408 may select a pixel of shorter-exposure image 404 for inclusion in the relevant composite image. For instance, HDR system 408 may select a pixel of shorter-exposure image 404 for inclusion in composite image 412 for each brighter pixel of motion mask 414 (brighter pixels of motion mask 414 indicate motion values that exceed motion threshold 410). Similarly, HDR system 408 may select a pixel of shorter-exposure image 404 for inclusion in composite image 432 for each brighter pixel of motion mask 434 (brighter pixels of motion mask 434 indicate motion values that exceed motion threshold 430).

Area 416 and area 424 in motion mask 414 include some brighter pixels. The brighter pixels in area 416 and area 424 may be based on noise in shorter-exposure image 404 (and/or based on a difference between noise in shorter-exposure image 404 and noise in longer-exposure image 406) exceeding motion threshold 410. Because area 416 and area 424 include brighter pixels, area 416 and area 424 in composite image 412 are based on shorter-exposure image 404. Area 416 and area 424 are darker (e.g., underexposed) in shorter-exposure image 404. Thus, area 416 and area 424 exhibit noise in composite image 412.

Area 436 and area 444 in motion mask 434 include fewer brighter pixels than area 416 and area 424 in motion mask 414. Because motion threshold 430 is higher than motion threshold 410, the noise of shorter-exposure image 404 (and/or the difference between the noise in shorter-exposure image 404 and the noise in longer-exposure image 406) may not exceed motion threshold 430, even though it exceeds motion threshold 410. Because area 436 and area 444 in motion mask 434 include few (or no) brighter pixels, area 436 and area 444 in composite image 432 may include pixels based on longer-exposure image 406 and/or based on a blending between pixels of shorter-exposure image 404 and pixels of longer-exposure image 406. As such, area 436 and area 444 in composite image 432 may exhibit less noise than area 416 and area 424 in composite image 412.

Area 440 in motion mask 434 includes fewer brighter pixels than the number of brighter pixels in area 420 in motion mask 414. The brighter pixels of area 440 of motion mask 434 may result in pixels of shorter-exposure image 404 being included in area 440 of composite image 432. The darker pixels in area 440 of motion mask 434 may result in pixels of longer-exposure image 406 being included in area 440 of composite image 432 (e.g., based on area 440 of shorter-exposure image 404 being underexposed). Area 440 of composite image 432 including pixels of shorter-exposure image 404 and longer-exposure image 406 may cause ghosting, for example, pixels representing the hand of the person at more than one position in composite image 432. For example, area 440 in composite image 432 may include pixels of shorter-exposure image 404 that represent the hand and pixels of longer-exposure image 406 that represent the hand.

Area 420 in motion mask 414 includes more brighter pixels than the number of brighter pixels in area 440 in motion mask 434. The brighter pixels of area 420 of motion mask 414 May result in pixels of shorter-exposure image 404 being included in area 420 of composite image 412. Including pixels of shorter-exposure image 404 in area 420 of composite image 412 may preclude including corresponding pixels of longer-exposure image 406 in area 420 of composite image 412. Because there are more brighter pixels in area 420 of motion mask 414 than in area 440 of motion mask 434, more pixels of area 420 in composite image 412 may be selected from shorter-exposure image 404 than the number of pixels of area 440 in composite image 432 that are selected from shorter-exposure image 404. Additionally, because there are more brighter pixels in area 420 of motion mask 414 than in area 440 of motion mask 434, fewer pixels of area 420 in composite image 412 may be based on longer-exposure image 406 than the number of pixels of area 440 in composite image 432 that are based on longer-exposure image 406. Selecting more pixels from shorter-exposure image 404 than from longer-exposure image 406 may prevent the selection of pixels representing moving objects from longer-exposure image 406. Thus, area 420 of composite image 412 exhibits less ghosting than area 440 of composite image 432.

A relatively low motion threshold may result in less ghosting than a relatively high motion threshold. However, a relatively high motion threshold may result in less noise than a relatively low motion threshold. Neither of composite image 412 of FIG. 4A (determined using a relatively low motion threshold 410) or composite image 432 of FIG. 4B (determined using a relatively high motion threshold 430) is ideal.

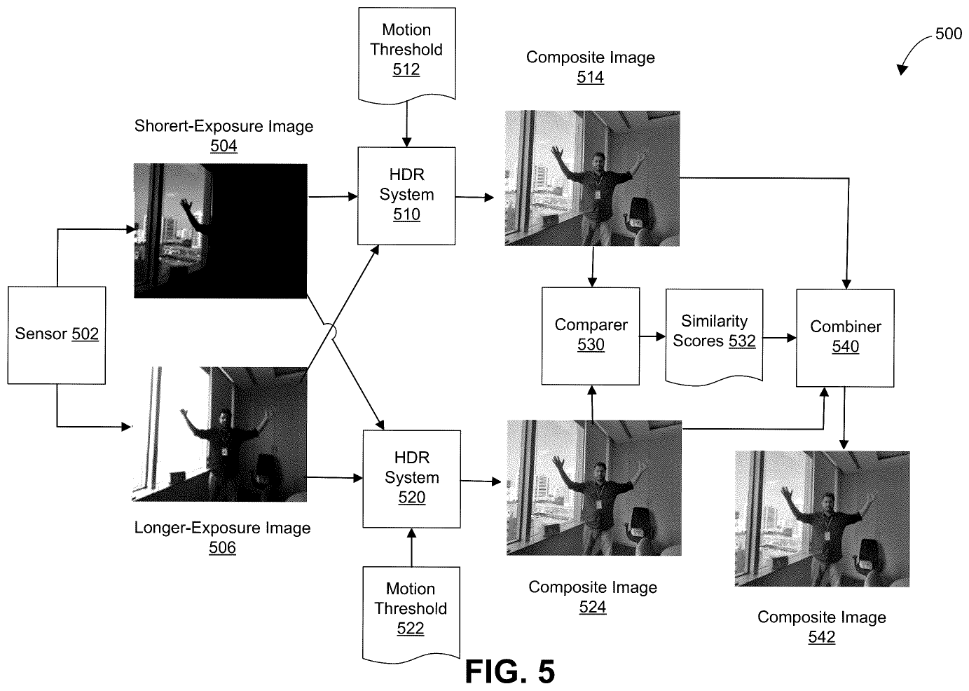

FIG. 5 is a block diagram with example images illustrating an example system 500 for generating a composite image 542 based on a shorter-exposure image 504 and a longer-exposure image 506, according to various aspects of the present disclosure. System 500 may generate composite image 542 with relatively low noise and relatively low ghosting. System 500 may have the advantages of a relatively low motion threshold and the advantages of a relatively high motion threshold.

Sensor 502 may be an image sensor capable of capturing light and generating image data. Image-capture device 102 of FIG. 1 may be an example of sensor 502. Sensor 502 may generate shorter-exposure image 504 and longer-exposure image 506. Shorter-exposure image 504 may be captured over a shorter exposure time than longer-exposure image 506.

HDR system 326 of FIG. 3 may be an example of HDR system 510 and HDR system 520 of FIG. 5. For example, HDR system 510 and HDR system 520 may combine pixels of shorter-exposure image 504 with pixels of longer-exposure image 506 based on intensities of shorter-exposure image 504 and longer-exposure image 506 and based on motion values.

HDR system 510 may generate composite image 514 based on shorter-exposure image 504, longer-exposure image 506, and motion threshold 512. Motion threshold 512 may be a relatively low motion threshold. For example, motion threshold 512 may be lower than motion threshold 522. HDR system 510 generating composite image 514 based on shorter-exposure image 504, longer-exposure image 506, and motion threshold 512 may be substantially similar to HDR system 408 generating composite image 412 based on shorter-exposure image 404, longer-exposure image 406, and motion threshold 410.

HDR system 520 may generate composite image 524 based on shorter-exposure image 504, longer-exposure image 506, and motion threshold 522. Motion threshold 522 may be a relatively high motion threshold. For example, motion threshold 522 may be higher than motion threshold 512. HDR system 520 generating composite image 524 based on shorter-exposure image 504, longer-exposure image 506, and motion threshold 522 may be substantially similar to HDR system 408 generating composite image 432 based on shorter-exposure image 404, longer-exposure image 406, and motion threshold 430.

Comparer 530 may compare composite image 514 with composite image 524 and generate similarity scores 532 based on the comparison. For example, comparer 530 may identify regions of composite image 514 and corresponding regions of composite image 524. Comparer 530 may compare each region of composite image 514 with a corresponding region of composite image 524 and determine a similarity score of similarity scores 532 based on the comparison. As such, similarity scores 532 may be, or may include, a similarity score for each region of composite image 514. The number and/or size of regions may be a hyper parameter of system 500 and may be configurable.

Comparer 530 may compare composite image 514 with composite image 524 by comparing groups of pixels of a region of composite image 514 with groups of pixels of a corresponding region of composite image 524. Comparer 530 may compare luminance values, contrast values, and/or structure values. Comparer 530 may compare using means and variances. In some aspects, comparer 530 may compare composite image 514 with composite image 524 using a structural-similarity (SSIM) algorithm.

Combiner 540 may combine composite image 514 with composite image 524 based on similarity scores 532. For example, combiner 540 may select regions of composite image 514 and regions of composite image 524 to include in composite image 542 based on similarity scores 532 of the regions.

Because motion threshold 522 is higher than motion threshold 512, composite image 524 may exhibit more ghosting than composite image 514. Because motion threshold 512 is lower than motion threshold 522, composite image 514 may exhibit more noise than composite image 524.

A region of composite image 524 that includes ghosting may be more similar (e.g., in terms of structure similarity) to a corresponding region of composite image 514 than a region of composite image 514 that includes noise is to a corresponding region of composite image 524. For example, area 440 of composite image 432 may be more similar (e.g., in terms of structure similarity) to area 420 of composite image 412 than area 416 of composite image 412 is to area 436 of composite image 432. As such, regions of composite image 514 and composite image 524 in which one of the regions (e.g., of composite image 524) includes ghosting may have higher similarity scores (in similarity scores 532) than regions of composite image 514 and composite image 524 in which one of the regions (e.g., of composite image 514) includes noise. Thus, similarity scores 532 (which may be based on a structural similarity between composite image 514 and composite image 524) may be used to differentiate regions of composite image 514 and composite image 524 that exhibit noise from regions of composite image 514 and composite image 524 that exhibit ghosting.

Composite image 524 may exhibit more ghosting than composite image 514 (based on motion threshold 522 being higher than motion threshold 512). Composite image 514 may exhibit more noise than composite image 524 (based on motion threshold 512 being lower than motion threshold 522). Combiner 540 may use similarity scores 532 to identify regions of composite image 514 that include noise and for such regions, include corresponding regions of composite image 524 in composite image 542. In some aspects, combiner 540 may select the remainder of the regions for composite image 542 from composite image 514.

By identifying regions of composite image 514 that exhibit noise and using regions of composite image 524 in place of such regions when generating composite image 542, system 500 may reduce or eliminate noise from composite image 542 as compared to composite image 514. Additionally or alternatively, by including regions of composite image 524 that do not exhibit noise when generating composite image 542, system 500 may reduce noise as compared to composite image 514.

In some aspects, system 500 may include a supervisor function (not illustrated in FIG. 5) that may oversee operations of system 500. For example, the supervisor function may obtain sensor inputs (e.g., from inertial measurement units (IMUs), cameras, motion detectors, and/or photosensors) indicative of scene conditions (such as local motion, global motion, and/or lighting). The supervisor may determine to enable or disable at least some operations of system 500 based on the scene conditions. For example, the scene conditions may be good for capturing low-noise, low-ghosting images. For instance, there may be little or no local motion and global motion. Further the scene may be well lit. In such cases the supervisor may determine to disable one of HDR system 510 or HDR system 520 and comparer 530 and combiner 540. As such, the supervisor may determine to enable one of HDR system 510 or HDR system 520 and to use one of composite image 514 or composite image 524 as an output. Further, the supervisor function may continue to observe the scene conditions and, responsive to a change in scene conditions, the supervisor function may enable the other of HDR system 510 and HDR system 520 and comparer 530 and combiner 540.

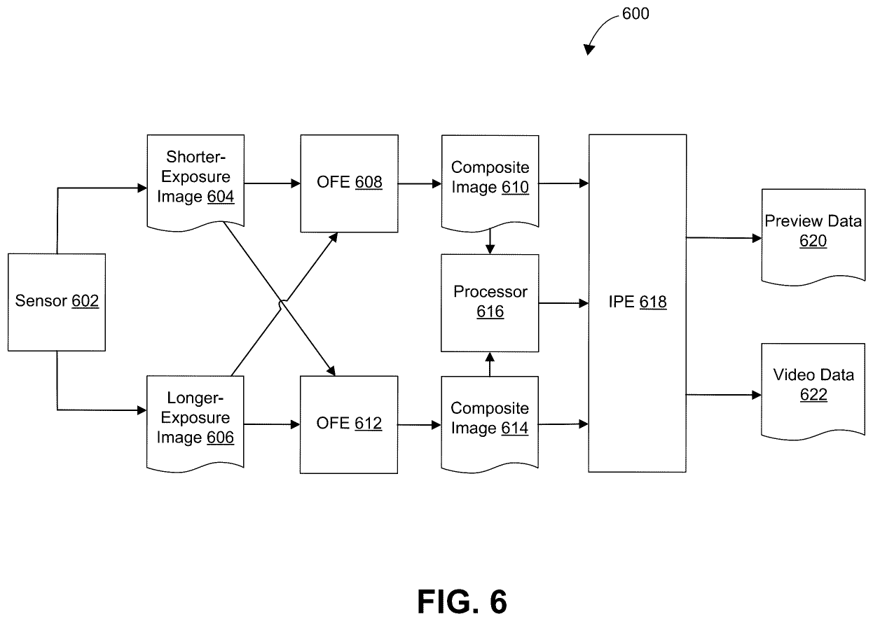

FIG. 6 is a block diagram illustrating an example system 600 for generating a composite image based on a shorter-exposure image 604 and a longer-exposure image 606. FIG. 6 provides an example of hardware that may be used to implement system 500. Sensor 602 may be an example of sensor 502 of FIG. 5. Shorter-exposure image 604 may be an example of shorter-exposure image 504 of FIG. 5. Longer-exposure image 606 may be an example of longer-exposure image 506 of FIG. 5.

Offline-front end (OFE) 608 may be an example of an image signal processor (ISP). OFE 608 may implement HDR system 510 of FIG. 5. For example, OFE 608 may generate composite image 610 based on shorter-exposure image 604 and longer-exposure image 606. OFE 608 may generate composite image 610 based on a relatively low motion threshold. Similarly, OFE 612 may be an example of another ISP. OFE 612 may implement HDR system 520 of FIG. 5. For example, OFE 612 may generate composite image 614 based on shorter-exposure image 604 and longer-exposure image 606. OFE 612 may generate composite image 614 based on a relatively high motion threshold.

Processor 616 may be, or may include, a graphics processing unit (GPU), central processing unit (CPU), or other processor. Processor 616 may implement comparer 530 of FIG. 5. For example, processor 616 may compare regions of composite image 610 with corresponding regions of composite image 614 and determine similarity scores based on the comparison.

Image processing electronics (IPE) 618 may be, or may include, a GPU or other electronics configured to perform operations on image data. IPE 618 may implement combiner 540 of FIG. 5. For example, IPE 618 may generate a composite image based on composite image 610, composite image 614, and similarity scores determined by processor 616. In some aspects, IPE 618 may perform additional image processing on the composite image.

IPE 618 may generate preview data 620 and/or video data 622 based on composite image 610, composite image 614, and/or the similarity scores determined by processor 616. For example, system 600 may be implemented in a device including a display. System 600 may process image data as it is captured (to generate composite image data) and display the composite image data as preview data 620 at the display. Additionally or alternatively, system 600 may store or display the composite image data as video data 622. For example, system 600 may operate in real time. For instance, system 600 may generate frames of composite image data as fast as sensor 602 captures frames of shorter-exposure image 604 and longer-exposure image 606. For instance, system 600 may operate at 30 frames per second (fps).

System 600 is given as an illustrative example. Other layouts of elements and/or distributions of operations are contemplated. For example, in an alternative system, one of OFE 608 or OFE 612 may be omitted and a single OFE may generate composite image 610 and composite image 614. The single OFE may generate composite image 610 first and composite image 614 second, for example, using the same hardware twice in succession. Alternatively, the single OFE may generate composite image 610 and composite image 614 at substantially the same time, for example, using parallel pathways within the single OFE. As another example, the similarity score may be determined at IPE 618 and processor 616 may be omitted.

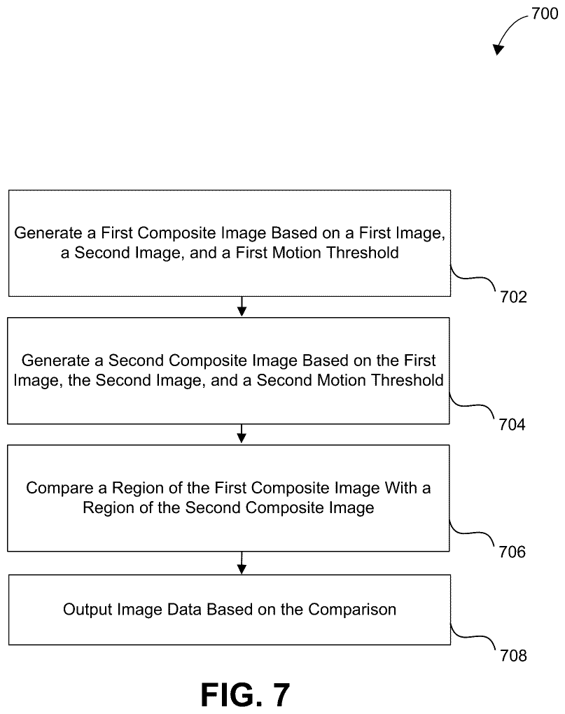

FIG. 7 is a flow diagram illustrating an example process 700 for generating composite images, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 700. The one or more operations of process 700 may be implemented as software components that are executed and run on one or more processors.

At block 702, a computing device (or one or more components thereof) may generate a first composite image based on a first image, a second image, and a first motion threshold. For example, HDR system 510 of FIG. 5 may generate composite image 514 based on shorter-exposure image 504, longer-exposure image 506, and motion threshold 512.

In some aspects, the first image may be captured using a first exposure duration. The second image may be captured using a second exposure duration. The second exposure duration may be longer than the first exposure duration. For example, shorter-exposure image 504 may be a shorter-exposure image and longer-exposure image 506 may be a longer-exposure image.

In some aspects, to generate the first composite image, the computing device (or one or more components thereof) may: determine a motion value based on the first image and the second image; and combine, based on the motion value and the first motion threshold, pixels of the first image with pixels of the second image to determine pixels for the first composite image. For example, HDR system 510 may determine motion values based on shorter-exposure image 504, longer-exposure image 506. HDR system 510 may combine shorter-exposure image 504 and longer-exposure image 506 to generate composite image 514 based on the motion values and motion threshold 512.

At block 704, the computing device (or one or more components thereof) may generate a second composite image based on the first image, the second image, and a second motion threshold. For example, HDR system 520 of FIG. 5 may generate composite image 524 based on shorter-exposure image 504, longer-exposure image 506, and motion threshold 522.

In some aspects, to generate the second composite image, the computing device (or one or more components thereof) may: determine a motion value based on the first image and the second image; and combine, based on the motion value and the second motion threshold, pixels of the first image with pixels of the second image to determine pixels for the second composite image. For example, HDR system 520 may determine motion values based on shorter-exposure image 504, longer-exposure image 506. HDR system 520 may combine shorter-exposure image 504 and longer-exposure image 506 to generate composite image 514 based on the motion values and motion threshold 522.

In some aspects, the second motion threshold may be greater than the first motion threshold. For example, motion threshold 512 may be a relatively low motion threshold and motion threshold 522 may be a relatively high motion threshold. For instance, motion threshold 522 may be greater than motion threshold 512.

In some aspects, a first image signal processor (ISP) may generate the first composite image; and a second ISP may generate the second composite image. For example, OFE 608 of FIG. 6 may generate composite image 610 and OFE 612 of FIG. 6 may generate composite image 614.

In some aspects, an image signal processor (ISP) may generate the first composite image and the second composite image. For example, a single ISP may generate both composite image 610 and composite image 614. In some aspects, the single ISP may generate composite image 610 and composite image 614 at substantially the same time, for example, in parallel. In some aspects, the single ISP may generate one of composite image 610 and composite image 614 before the other.

At block 706, the computing device (or one or more components thereof) may compare a region of the first composite image with a region of the second composite image. For example, comparer 530 of FIG. 5 may compare a region of composite image 514 with a corresponding region of composite image 524.

At block 708, the computing device (or one or more components thereof) may output image data based on the comparison. For example, system 500 may output composite image 542 based, at least in part, on the comparison performed by comparer 530.

In some aspects, the computing device (or one or more components thereof) may compare a first region of the first composite image to a first region of the second composite image to determine a first similarity score; compare a second region of the first composite image to a second region of the second composite image to determine a second similarity score; and generate a third composite image based on the first composite image, the second composite image, the first similarity score and the second similarity score. For example, comparer 530 may compare a first region of composite image 514 with a corresponding first region of composite image 524 to generate a first similarity score of similarity scores 532. Further, comparer 530 may compare a second region of composite image 514 with a corresponding second region of composite image 524 to generate a second similarity score of similarity scores 532.

In some aspects, to generate the third composite image, the computing device (or one or more components thereof) may: compare the first similarity score to a similarity threshold; and include, in the third composite image, the first region of the first composite image based on the first similarity score exceeding the similarity threshold. For example, combiner 540 of FIG. 5 may compare the first similarity score to a similarity threshold and include the first region of composite image 514 in composite image 542 based on the first similarity score exceeding the similarity threshold.

In some aspects, to generate the third composite image, the computing device (or one or more components thereof) may: compare the first similarity score to a similarity threshold; and include, in the third composite image, the first region of the second composite image based on the first similarity score being less than the similarity threshold. For example, combiner 540 of FIG. 5 may compare the first similarity score to a similarity threshold and include the first region of composite image 524 in composite image 542 based on the first similarity score being less than the similarity threshold.

In some aspects, to determine the first similarity score, the computing device (or one or more components thereof) may determine a structural similarity score of the first region of the first composite image and the first region of the second composite image. For example, comparer 530 may determine similarity scores 532 as structural similarity scores.

In some examples, as noted previously, the methods described herein (e.g., process 700 of FIG. 7, and/or other methods described herein) can be performed, in whole or in part, by a computing device or apparatus. In one example, one or more of the methods can be performed by system 500 of FIG. 5 system 600 of FIG. 6, or by another system or device. In another example, one or more of the methods (e.g., process 700, and/or other methods described herein) can be performed, in whole or in part, by the computing-device architecture 800 shown in FIG. 8. For instance, a computing device with the computing-device architecture 800 shown in FIG. 8 can include, or be included in, the components of the system 500 and/or system 600 and can implement the operations of process 700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 8 illustrates an example computing-device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 800 may include, implement, or be included in any or all of system 500 of FIG. 5, system 600 of FIG. 6, and/or other devices, modules, or systems described herein. Additionally or alternatively, computing-device architecture 800 may be configured to perform process 700, and/or other process described herein.

The components of computing-device architecture 800 are shown in electrical communication with each other using connection 812, such as a bus. The example computing-device architecture 800 includes a processing unit (CPU or processor) 802 and computing device connection 812 that couples various computing device components including computing device memory 810, such as read only memory (ROM) 808 and random-access memory (RAM) 806, to processor 802.

Computing-device architecture 800 can include a cache of high-speed memory connected directly with, in close proximity to, or integrated as part of processor 802. Computing-device architecture 800 can copy data from memory 810 and/or the storage device 814 to cache 804 for quick access by processor 802. In this way, the cache can provide a performance boost that avoids processor 802 delays while waiting for data. These and other modules can control or be configured to control processor 802 to perform various actions. Other computing device memory 810 may be available for use as well. Memory 810 can include multiple different types of memory with different performance characteristics. Processor 802 can include any general-purpose processor and a hardware or software service, such as service 1 816, service 2 818, and service 3 820 stored in storage device 814, configured to control processor 802 as well as a special-purpose processor where software instructions are incorporated into the processor design. Processor 802 may be a self-contained system, containing multiple cores or processors, a bus, memory controller, cache, etc. A multi-core processor may be symmetric or asymmetric.

To enable user interaction with the computing-device architecture 800, input device 822 can represent any number of input mechanisms, such as a microphone for speech, a touch-sensitive screen for gesture or graphical input, keyboard, mouse, motion input, speech and so forth. Output device 824 can also be one or more of a number of output mechanisms known to those of skill in the art, such as a display, projector, television, speaker device, etc. In some instances, multimodal computing devices can enable a user to provide multiple types of input to communicate with computing-device architecture 800. Communication interface 826 can generally govern and manage the user input and computing device output. There is no restriction on operating on any particular hardware arrangement and therefore the basic features here may easily be substituted for improved hardware or firmware arrangements as they are developed.

Storage device 814 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 806, read only memory (ROM) 808, and hybrids thereof. Storage device 814 can include services 816, 818, and 820 for controlling processor 802. Other hardware or software modules are contemplated. Storage device 814 can be connected to the computing device connection 812. In one aspect, a hardware module that performs a particular function can include the software component stored in a computer-readable medium in connection with the necessary hardware components, such as processor 802, connection 812, output device 824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for generating composite image data, the apparatus comprising: at least one memory; and at least one processor coupled to the at least one memory and configured to: generate a first composite image based on a first image, a second image, and a first motion threshold; generate a second composite image based on the first image, the second image, and a second motion threshold; compare a region of the first composite image with a region of the second composite image; and output image data based on the comparison.
Aspect 2. The apparatus of aspect 1, wherein the at least one processor is configured to: compare a first region of the first composite image to a first region of the second composite image to determine a first similarity score; compare a second region of the first composite image to a second region of the second composite image to determine a second similarity score; and generate a third composite image based on the first composite image, the second composite image, the first similarity score and the second similarity score.
Aspect 3. The apparatus of aspect 2, wherein, to generate the third composite image, the at least one processor is configured to: compare the first similarity score to a similarity threshold; and include, in the third composite image, the first region of the first composite image based on the first similarity score exceeding the similarity threshold.
Aspect 4. The apparatus of any one of aspects 2 or 3 wherein, to generate the third composite image, the at least one processor is configured to: compare the first similarity score to a similarity threshold; and include, in the third composite image, the first region of the second composite image based on the first similarity score being less than the similarity threshold.
Aspect 5. The apparatus of any one of aspects 2 to 4, wherein, to determine the first similarity score, the at least one processor is configured to determine a structural similarity score of the first region of the first composite image and the first region of the second composite image.
Aspect 6. The apparatus of any one of aspects 1 to 5, wherein: the first image is captured using a first exposure duration; the second image is captured using a second exposure duration; and the second exposure duration is longer than the first exposure duration.
Aspect 7. The apparatus of any one of aspects 1 to 6, wherein, to generate the first composite image, the at least one processor is configured to: determine a motion value based on the first image and the second image; and combine, based on the motion value and the first motion threshold, pixels of the first image with pixels of the second image to determine pixels for the first composite image.
Aspect 8. The apparatus of any one of aspects 1 to 7, wherein the second motion threshold is greater than the first motion threshold.
Aspect 9. The apparatus of any one of aspects 1 to 8, further comprising: a first image signal processor (ISP) configured to generate the first composite image; and a second ISP configured to generate the second composite image.
Aspect 10. The apparatus of any one of aspects 1 to 8, further comprising an image signal processor (ISP) configured to generate the first composite image and the second composite image.
Aspect 11. A method for generating composite image data, the method comprising: generating a first composite image based on a first image, a second image, and a first motion threshold; generating a second composite image based on the first image, the second image, and a second motion threshold; comparing a region of the first composite image with a region of the second composite image; and outputting image data based on the comparison.
Aspect 12. The method of aspect 11, further comprising: comparing a first region of the first composite image to a first region of the second composite image to determine a first similarity score; comparing a second region of the first composite image to a second region of the second composite image to determine a second similarity score; and generating a third composite image based on the first composite image, the second composite image, the first similarity score and the second similarity score.
Aspect 13. The method of aspect 12, wherein generating the third composite image comprises: comparing the first similarity score to a similarity threshold; and including, in the third composite image, the first region of the first composite image based on the first similarity score exceeding the similarity threshold.
Aspect 14. The method of any one of aspects 12 or 13, wherein generating the third composite image comprises: comparing the first similarity score to a similarity threshold; and including, in the third composite image, the first region of the second composite image based on the first similarity score being less than the similarity threshold.
Aspect 15. The method of any one of aspects 12 to 14, wherein determining the first similarity score comprises determining a structural similarity score of the first region of the first composite image and the first region of the second composite image.
Aspect 16. The method of any one of aspects 11 to 15, wherein: the first image is captured using a first exposure duration; the second image is captured using a second exposure duration; and the second exposure duration is longer than the first exposure duration.
Aspect 17. The method of any one of aspects 11 to 16, wherein generating the first composite image comprises: determining a motion value based on the first image and the second image; and combining, based on the motion value and the first motion threshold, pixels of the first image with pixels of the second image to determine pixels for the first composite image.
Aspect 18. The method of any one of aspects 11 to 17, wherein the second motion threshold is greater than the first motion threshold.
Aspect 19. The method of any one of aspects 11 to 18, wherein: first composite image is generated at a first image signal processor (ISP); and the second composite image is generated at a second ISP.
Aspect 20. The method of any one of aspects 11 to 18, wherein the first composite image and the second composite image are generated at an image signal processor (ISP).
Aspect 21. A non-transitory computer-readable storage medium having stored thereon instructions that, when executed by at least one processor, cause the at least one processor to perform operations according to any of aspects 11 to 20.
Aspect 22. An apparatus for providing virtual content for display, the apparatus comprising one or more means for perform operations according to any of aspects 11 to 20.

What is claimed is:

1. An apparatus for generating composite image data, the apparatus comprising:
at least one memory; and
at least one processor coupled to the at least one memory and configured to:
generate a first composite image based on a first image, a second image, and a first motion threshold;
generate a second composite image based on the first image, the second image, and a second motion threshold;
compare a region of the first composite image with a region of the second composite image; and
output image data based on the comparison.

2. The apparatus of claim 1, wherein the at least one processor is configured to:
compare a first region of the first composite image to a first region of the second composite image to determine a first similarity score;
compare a second region of the first composite image to a second region of the second composite image to determine a second similarity score; and
generate a third composite image based on the first composite image, the second composite image, the first similarity score and the second similarity score.

3. The apparatus of claim 2, wherein, to generate the third composite image, the at least one processor is configured to:
compare the first similarity score to a similarity threshold; and
include, in the third composite image, the first region of the first composite image based on the first similarity score exceeding the similarity threshold.

4. The apparatus of claim 2, wherein, to generate the third composite image, the at least one processor is configured to:
compare the first similarity score to a similarity threshold; and
include, in the third composite image, the first region of the second composite image based on the first similarity score being less than the similarity threshold.

5. The apparatus of claim 2, wherein, to determine the first similarity score, the at least one processor is configured to determine a structural similarity score of the first region of the first composite image and the first region of the second composite image.

6. The apparatus of claim 1, wherein:
the first image is captured using a first exposure duration;
the second image is captured using a second exposure duration; and
the second exposure duration is longer than the first exposure duration.

7. The apparatus of claim 1, wherein, to generate the first composite image, the at least one processor is configured to:
determine a motion value based on the first image and the second image; and
combine, based on the motion value and the first motion threshold, pixels of the first image with pixels of the second image to determine pixels for the first composite image.

8. The apparatus of claim 1, wherein the second motion threshold is greater than the first motion threshold.

9. The apparatus of claim 1, further comprising:
a first image signal processor (ISP) configured to generate the first composite image; and
a second ISP configured to generate the second composite image.

10. The apparatus of claim 1, further comprising an image signal processor (ISP) configured to generate the first composite image and the second composite image.

11. A method for generating composite image data, the method comprising:
generating a first composite image based on a first image, a second image, and a first motion threshold;
generating a second composite image based on the first image, the second image, and a second motion threshold;
comparing a region of the first composite image with a region of the second composite image; and
outputting image data based on the comparison.

12. The method of claim 11, further comprising:
comparing a first region of the first composite image to a first region of the second composite image to determine a first similarity score;
comparing a second region of the first composite image to a second region of the second composite image to determine a second similarity score; and
generating a third composite image based on the first composite image, the second composite image, the first similarity score and the second similarity score.

13. The method of claim 12, wherein generating the third composite image comprises:
comparing the first similarity score to a similarity threshold; and
including, in the third composite image, the first region of the first composite image based on the first similarity score exceeding the similarity threshold.

14. The method of claim 12, wherein generating the third composite image comprises:
comparing the first similarity score to a similarity threshold; and
including, in the third composite image, the first region of the second composite image based on the first similarity score being less than the similarity threshold.

15. The method of claim 12, wherein determining the first similarity score comprises determining a structural similarity score of the first region of the first composite image and the first region of the second composite image.

16. The method of claim 11, wherein:
the first image is captured using a first exposure duration;
the second image is captured using a second exposure duration; and
the second exposure duration is longer than the first exposure duration.

17. The method of claim 11, wherein generating the first composite image comprises:
determining a motion value based on the first image and the second image; and
combining, based on the motion value and the first motion threshold, pixels of the first image with pixels of the second image to determine pixels for the first composite image.

18. The method of claim 11, wherein the second motion threshold is greater than the first motion threshold.

19. The method of claim 11, wherein:
first composite image is generated at a first image signal processor (ISP); and
the second composite image is generated at a second ISP.

20. The method of claim 11, wherein the first composite image and the second composite image are generated at an image signal processor (ISP).
